(19) United States
(12) Patent Application Publication
(10) Pub. No.: US 2010/0304704 A1
(43) Pub. Date: Dec. 2, 2010

(54) Wireless Phone with Lanyard Antenna

(76) Inventor: Hamid Najafi, Incline Village, NV (US)

Correspondence Address: Hamid Najafi, 774 Mays Blvd #10, PMB 263, Incline Village, NV, 89451, US

(21) Appl. No.: 11/720,760

(22) PCT Filed: Nov. 30, 2005
(86) PCT No.: PCT/US05/43624

§ 371 Date: Jun. 3, 2007

Related U.S. Application Data
(60) Provisional application No. 60/633,685, filed on Dec. 6, 2004.

(51) Int. Cl. H04M 11/04; H04M 1/00; H04M 3/42

(52) U.S. Cl. 455/404.1; 455/562.1; 455/415

(57) ABSTRACT

A wireless phone has an antenna disposed within a lanyard shape. The phone also has two sets of keys, each set separately accessible via a separate bezel. The phone increases SAR during emergency calls. The phone only allows authorized users to call the phone.

### TECHNICAL FIELD

This invention relates generally to wireless phones, and more particularly, but not exclusively, provides a wireless phone with a lanyard antenna and method of use thereof.

### BACKGROUND

Wireless phones are being used by millions of people around the world. They typically have a keypad similar to a standard touch tone phone used for dialing or other feature activation.

Conventional wireless phones may be too complicated for use by children and older adults due to the plurality of keys and functions available. In addition, there is much room for improvement of safety features of conventional wireless phones.

### SUMMARY

In an embodiment of the invention, a wireless phone has an antenna disposed in a lanyard-shaped fin, the fin coupled to the phone at 2 points, the antenna coupled to a transceiver within the phone.

In another embodiment, a wireless phone has two sets of keys, the sets each having a different number of keys, the sets of keys each separately accessible via the placement of bezel corresponding to the different sets of keys.

In an embodiment of the invention, a method, comprises: receiving an indication to dial a phone number; determining if the phone number is an emergency number; increasing the transmitter power, thus increasing SAR level, of a wireless phone if the phone number is an emergency number; and dialing the phone number.

In an embodiment of the invention, a method, comprises: receiving a call; determining the phone number of the caller; determining if the phone number matches an authorized phone number; and generating a ring tone if the phone number matches an authorized number.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating a wireless phone according to an embodiment of the invention;

FIG. 2 is a block diagram illustrating the wireless phone;

FIG. 3 is a block diagram illustrating persistent memory of the wireless phone;

FIG. 4 is a flowchart illustrating a method of dialing a number using the wireless phone;

FIG. 5 is a flowchart illustrating a method of receiving a call using the wireless phone;

FIG. 6 is a flowchart illustrating a method of programming the wireless phone;

FIG. 7 is a diagram illustrating data entry with the wireless phone;

FIG. 8 is a diagram illustrating assembly of an antenna of the phone; and

FIG. 9 is a diagram illustrating a wireless phone with interchangeable keypads.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

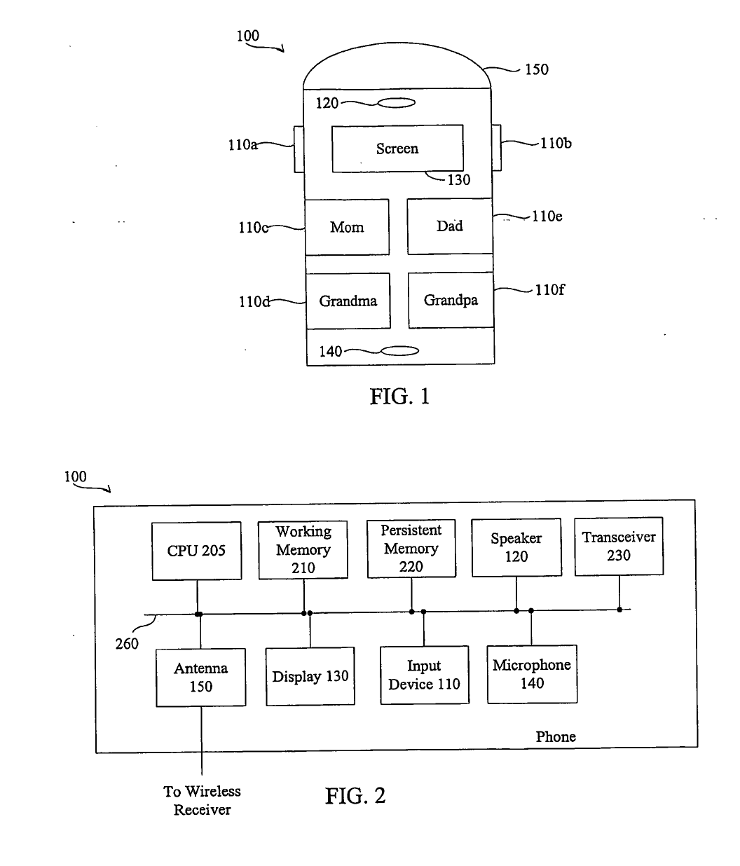

FIG. 1 is a diagram illustrating a wireless phone 100 according to an embodiment of the invention. The wireless phone 100 described here uses a small number of keys for its operation. It uses a combination of voice activation, key strokes, and remote messaging to operate the features of the phone 100. It can be a cellular phone, a cordless phone, or any other wireless phone. The invention described here can also be applied in a wired phone.

The phone 100 described here is a small wireless phone which operates under the International GSM standard or other standard, such as CDMA. It has four or more keys 110c, 110d, 110e, and 110f on the front and one or more keys 110a, 110b on each side. The front keys 110c-f are used for selecting a phone number to call or to answer, the one or more side keys 110a on the left are used for volume control (audio, ringer, or key beeps) and the one or more keys 110b on the right are used as SEND and END keys. The front keys 110c, 110d, 110e and 110f each have a printed label to identify each key as the number to call. The labels can specify a number, person (by name, nickname, and/or relationship) or both.

The phone 100 also has a display screen 130 located above keys 110c-110f on a front face of the phone 100. The display screen 130 is located approximately equidistant between keys 110a and 110b at about the same vertical position as the keys 110a and 110b. Above the screen 130 is a speaker 120 and below the buttons 110d and 110f is a microphone 140. An antenna 150 has a lanyard shape extending from the top sides of the phone 100.

FIG. 2 is a block diagram illustrating the wireless phone 100. The phone 100 includes a central processing unit (CPU) 205; a working memory 210; a persistent memory 220; a speaker 120, a transceiver 230, an antenna 150, a display 130, an input device 110, and a microphone 140; all communicatively coupled to each other via a bus 260. The CPU 205 may include an ARM 7 microprocessor, or any other processor capable to execute software stored in the persistent memory 220. The working memory 210 may include random access memory (RAM) or any other type of read/write memory devices or combination of memory devices. The persistent memory 220 may include a hard drive, a FLASH memory, a read only memory (ROM) or any other type of memory device or combination of memory devices that can retain data after the reservation system 130 is shut off. The display 130 may include a liquid crystal display or other display. The input device 110 include keys and/or other input devices, such as a scroll wheel. The transceiver 130 converts audio data to and from radio waves. The antenna 150, which has a lanyard shape, receives and transmits the radio waves. The microphone 140 and the speaker 120 convert audio to data and data to audio, respectively.

FIG. 3 is a block diagram illustrating persistent memory 220 of the wireless phone 100. The memory 220 includes a voice recognition engine 310; a phone number database 320; a dialer engine 330; a called ID engine 340; an authorizer engine 350; a SMS engine 360; a Specific Absorption Rate (SAR) engine 370; and a text entry engine 380. The voice recognition engine 310 converts audio commands to data so that the dialer engine 330 can act accordingly. For example, a user can speak “Dad” into the microphone 140 and the voice recognition engine 310 can convert that into data corresponding to Dad. The dialer engine 330 will then look up the phone number corresponding to Dad in the phone number database 320 and call that number. The phone number database 320 includes phone numbers and corresponding names, nicknames, and/or relationships for users authorized to call the phone 100 and for the phone 100 to dial. Usually, the numbers will be authorized for both calling the phone 100 and to call using the phone 100. However, some numbers can be authorized for only or the other.

The dialer engine 330 dials numbers listed in the phone number database 320 when a key 110c-f is pressed and then key 110 is pressed or based on data from the voice recognition engine 310. The dialer engine 330 looks up a phone number corresponding to a pressed key or voice data in the phone number database 320 and then dials it. The caller ID engine 340 identifies the phone numbers of received calls and then compares them with numbers in the phone number database 320. If the phone number is not in the phone number database 320 or in the database 320 but not authorized to call the phone 100, then the received call is ignored and the user cannot receive the call. In an embodiment of the invention, there can be no indication that an unauthorized call was received. In another embodiment, a log can be kept of unauthorized calls on the phone 100 and/or the log can be stored elsewhere and/or the log can be emailed to an authorized person (e.g., the parent of the child user) such that the authorized person can determine if someone is trying to contact the child in an unauthorized manner (e.g., a non-custodial parent).

The authorizer engine 350 adds phone numbers temporarily to the database 320. In some occasions, a call is to be made to the phone using a number not pre-stored in the phone 100. This can be, for instance, a call by “Mom” when she is not calling from her usual number. To allow this kind of call to go through, but not open the phone to receiving calls from “unauthorized” callers, the following options are available:
1. The caller calls a call center and asks the operator to call the desired phone number. The operator will authenticate the caller as an “authorized” caller, and calls the phone 100 using a phone line recognizable by the called phone as an “authorized” call, i.e., from a phone number stored in the phone number database 320.
2. The caller calls the phone 100 directly; the phone does not ring but answers the call without enabling the microphone or speaker, and the authorizer engine 350, in conjunction with the voice recognition engine 310, listens for a “Password”. The caller utters a password and the authorizer engine 350 compares the password against a pre-stored list of passwords that can be used by the phone 100 to authenticate the caller.
3. The authorizer engine 350 has a security access code that allows the phone to receive any phone call within a specified period of time. The caller would send a SMS message to the phone 100 with the access code, the authorizer engine 350 will then allow any received call to be completed within the specified period of time.

The SMS engine 360 receives text messages from other phones or computers to program the phone 100, e.g., to add phone numbers to the database 320. A website can be used to craft SMS messages to send to the phone 100.

Many teachers use their school website to post the daily homework for the students and parents to view. A simpler approach is to allow the teachers, especially in the elementary schools, to send an SMS message to the kids' phone 100 with the daily homework assignments. The phone 110 will receive such messages sent from specially designed websites or specifically designated mobile phone numbers (the teacher's phone) and store them is a separate mailbox that can only be edited by parents or overwritten by the teacher (using her phone or our website). The parents can easily find out about the daily homework, without a need to use a computer. This is much more accessible and convenient than logging on to the teachers website, especially if the parents do not have or do not use a computer.

The SAR engine 370 adjusts the SAR according the call made. Conventional cellular phones, especially those complying with the GSM standard, are allowed to transmit up to two watts of power. However, due to health risk restrictions imposed by the international regulatory agencies, such as FCC or ETSI, the phones typically transmit less than this maximum power allowed. This is to limit the Specific Absorption Rate (SAR) to a level that is deemed safe for humans.

To minimize SAR, especially in phones designed for use by children, the phone 100 uses a lower transmit power, along with a lanyard antenna 150, which will be discussed in further detail below, to keep SAR about half of what typical phones are designed for. However, this may compromise the effectiveness of the phone 100 in weak signal areas but will not be generally noticeable by the user. To improve the effectiveness of the phone in an emergency, the phone 100 allows for a higher transmit level, only when a call is made to 911 or similar numbers, programmed in the phone 100. The SAR engine 370 temporarily increases the transmit level, but still meets the maximum SAR limits, to allow an emergency call have a better chance of a good connection.

The text entry engine 380 enables text entry as shown in FIG. 7. A screen 700 (FIG. 7) will display an existing text string associated with this entry in a title bar. This string will also be displayed in the ‘Text Entry Box’ (described below) where it can be edited using the 4-way navigation key and the execute key.
There are three distinct areas of the screen 700 which can be accessed using the 4-way navigation key.
1. The Alpha/Numeric Box
   The Alpha/Numeric section comprises four lines, two of which will be displayed at any one time. The 4-way navigation key will scroll up and down though this list. If the cursor is pressed beyond the bottom of the list, the cursor will move into the Text Entry Box. From the Alpha/Numeric Box if the cursor is moved beyond the right hand edge it will move into the Special Features Box.
2. The Text Entry Box
   Once in the text box the left and right arrows of the 4-way navigation key will allow the user to move the cursor, to any position on the line to insert text or delete text (using the back-space delete character), in the Special Features Box. If the number of character exceeds the limit of the display, then a right arrow will be displayed and the text will scroll to the right.
3. Special Features Box
   Once in the special characters section the user can either delete the previous character (backspace delete), shift (change case mode of subsequent entered text by scrolling through: ‘ABC’, ‘abc’, and ‘Abe’), insert a space or save changes. When the shift mode is toggled the characters displayed on the screen will change to reflect the current state (namely upper or lower case).
   Key[‘SEND’] to save the name and return to the previous menu.
   Key[‘END’] to return to the idle screen.

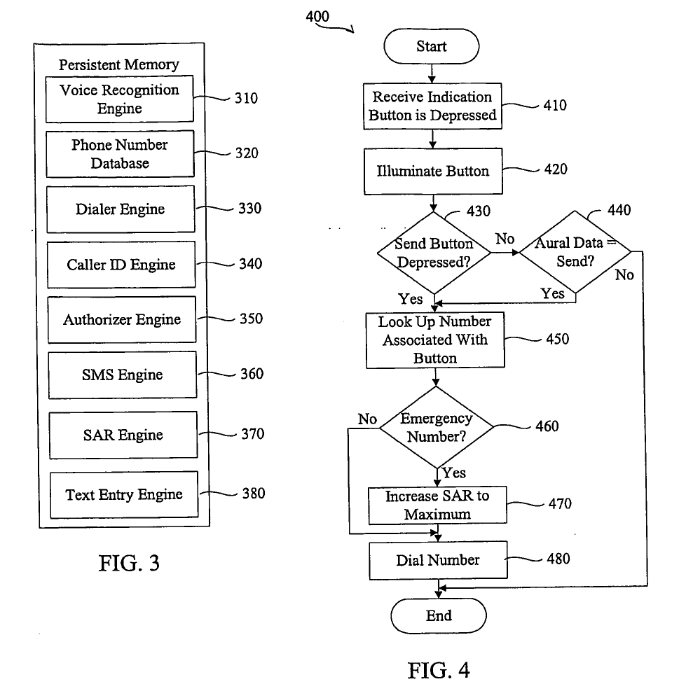

FIG. 4 is a flowchart illustrating a method 400 of dialing a number using the wireless phone 100. To make a call, a user presses one of the front keys 110c-110f, for instance the key 110c labeled “Mom”, followed by either pressing SEND key 110b or saying the word “Call” in English or other languages. When a front key 110c-f is pressed, an LED under the key lights up and stays lit until the call is made. If neither SEND key is pressed nor the word “Call’ is uttered within a fixed time (for instance 5 seconds) the LED will turn off and the front key must be pressed again if a call is to be made. This sequence is to minimize the possibility of unwanted calling due to unintentional pressing of a front key 110c-f.

The calls the phone 100 makes are restricted to the numbers pre-stored in the phone number database 320 and corresponding to the front keys 110c-f.

To call an emergency number, such as 911, a doctor, hospital, or other care provider, a caller presses three front keys 110 in a row (designated with numbers 9, 1, and 1) within a fixed time (say 3 seconds) between each key stroke, followed by a SEND key 110b or uttering the word “Call”. This sequence is also to minimize the possibility of accidental calling of 911. Another method to call 911 in an emergency is for the user to utter the words “Help Help”, at which time the dialer engine 330 calls the emergency number and opens the microphone 140 and speaker 120 for emergency communications.

In an embodiment of the invention, the method 400 receiving (410) an indication that a front button 110c-f has been depressed and illuminating (420) the depressed button. If (430) the send button 110b is not depressed, then it is determined (440) if there is aural data corresponding to a send request. If not, then the method 400 ends. Otherwise, the phone number associated with the button is looked up (450) in the phone number database 320. If (460) this is an emergency number, then the SAR is increased (470) to maximum and the emergency number called (480). If (460) not an emergency number, then the number is called (480) without increasing the SAR.

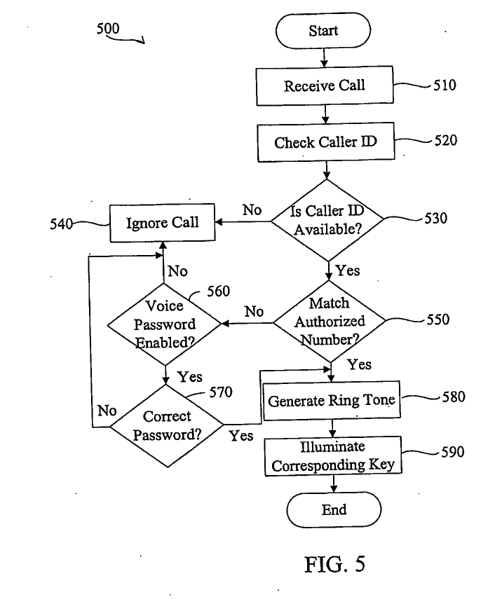

FIG. 5 is a flowchart illustrating a method 500 of receiving a call using the wireless phone 100. The calls the phone 100 can receive are also restricted to a few pre-stored numbers in the phone number database 320. When a call is received by the phone 100, the caller ID engine 340 checks the caller ID against a pre-stored list in the database 320. If it does not match it will not ring and it will not answer the call. If it does match an authorized number, then one of the LEDs under the front keys will light up corresponding to the phone number and the user can either press the front key, or say the word “answer”, to answer the call.

In an embodiment of the invention, the method 500 comprises receiving (510) a call and checking (520) caller ID. If (530) caller ID is not available, then the call can be ignored (540). If (550) the phone number matches an authorized number, a ring tone is generated (580) and a key 110c-f corresponding to the caller ID, if any, is illuminated (590). The method 500 then ends. If (550), the phone number does not match an authorized number, or in an embodiment of the invention if caller ID is unavailable, then if a voice password feature is not enabled (560), the call is ignored (540). Otherwise, if (560) the voice password feature is enabled and the correct password is supplied (570), the phone 100 generates (580) a ring tone. A corresponding key will not illuminate (590) as there is no caller ID to match an authorized phone number. The method 500 then ends.

In an embodiment of the invention, the generating (580) can instead or in addition generate a vibration. Accordingly, the term ring tone can be understood to be or include a vibration throughout this application.

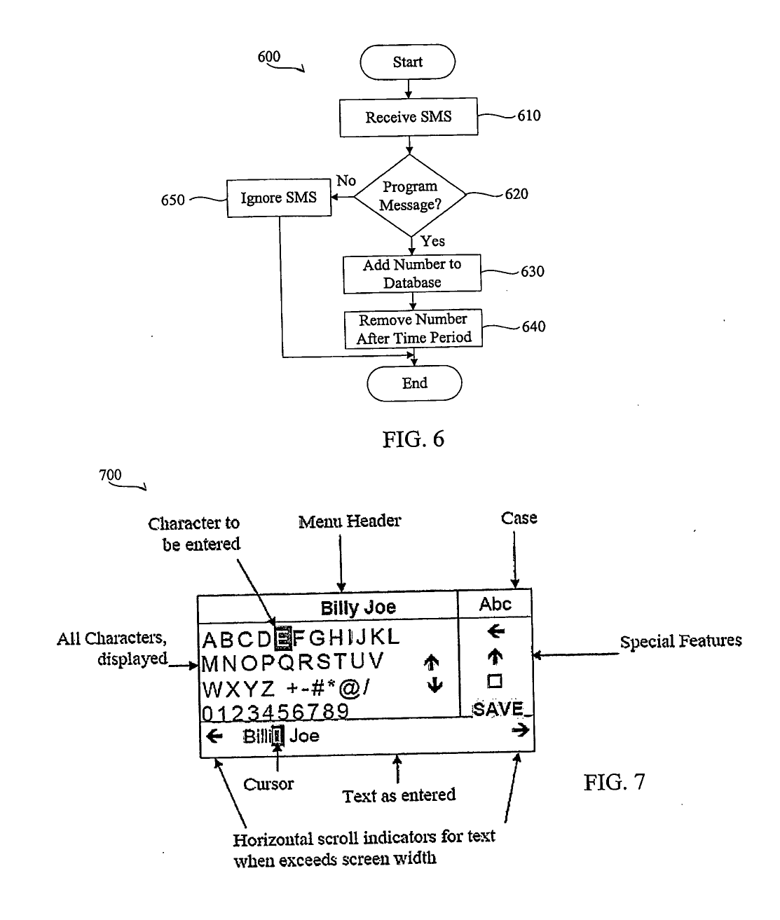

FIG. 6 is a flowchart illustrating a method of programming the wireless phone 100. First, an SMS message is received (610). If (620) it is not a program message, then the SMS is ignored (650). Otherwise, a phone number in the SMS message is added (630) to the phone number database 320 and then removed (640) after a set amount of time (e.g., 5 minutes). The method 600 then ends. Accordingly, the method 600 enables the temporary addition of a phone number to the phone number database 320 so that a caller can become temporarily authorized, e.g., an authorized caller calling from an unauthorized phone number (a phone number not usually used).

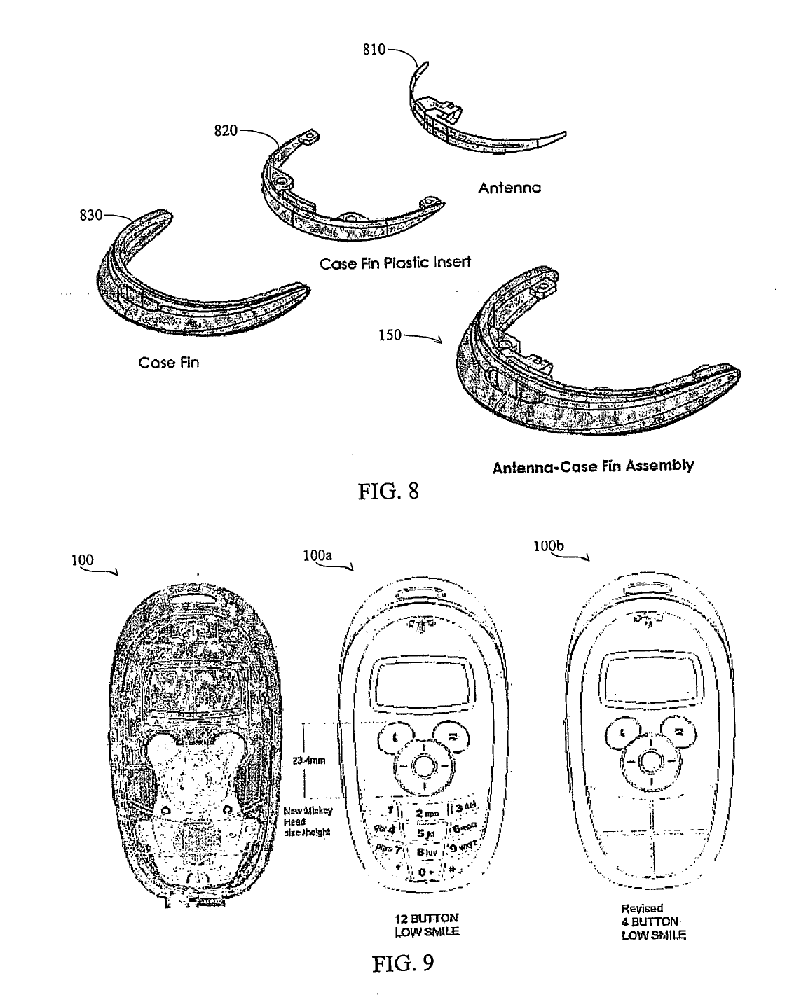

FIG. 8 is a diagram illustrating assembly of an antenna 150 of the phone 100. Wireless phone in general and cellular phones in particular typically use either an external antenna or an internal antenna. External antennae have the advantage of not being partially blocked by internal circuits of the phone and therefore having a better performance. The disadvantages are: a) esthetically they do not look as good as internal (non-visible) antennae and b) they are more susceptible to breakage, especially when used by children.

The antenna 150 combines the advantages of both types of antennae, by designing a “lanyard” holder section in the phone and designing an antenna that fits inside this section. Since the lanyard section is “external” to the main part of the phone, the antenna behaves, electrically, as an external antenna and has equivalent performance to an external antenna. However, since it is built in the plastic housing of the phone, esthetically behaves as an internal antenna. It does not look like an external antenna and it is not subject to the same durability problems other external antenna designs face.

The antenna 150 comprises an antenna 810 held in a case fin 830 having a lanyard shape by a case fin plastic insert 820. The case fin 830 is then coupled to the phone 100 such that the antenna 810 is in contact with the transceiver 230.

FIG. 9 is a diagram illustrating a wireless phone 100 with interchangeable keypads 100a and 100b. To create a limited use phone for children, the phone 100 is designed to have smaller dial pad, e.g., 4 keys instead of the typical 12 keys found in cellular phones. A number of kids' phones have been recently introduced in the market that use a smaller keypad for the same purpose. However, if the parent feels the limited key pad is too restrictive, or wants to upgrade the phone later on to a full keypad, none of the phones in the market allow that flexibility. In an embodiment of the invention the user can obtain keypad-bezel set and easily convert the phone to a 12-key design. The hardware inside the phone accommodates both keypads and the software automatically switches to the phone to appropriate keypad (4 or 12) functionality by sensing the presence the keypads.

The phone 100 includes two sets of keys, one set with a layout of four keys and one with a layout of twelve keys. By placing a 4-key bezel on the phone, only the four-key layout is accessible by pressing one of the 4 keys on the bezel. By placing a 12-key bezel on the phone, then only the twelve-key layout is accessible by pressing keys on the 12-key bezel. The 4-key layout is embedded in the 12-key layout such that only a total of 12 key sensors are used in the board layout, a subset of which are used for 4-key operation.

The foregoing description of the illustrated embodiments of the present invention is by way of example only, and other variations and modifications of the above-described embodiments and methods are possible in light of the foregoing teaching. For example, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A wireless phone having an antenna disposed in a lanyard-shaped fin, the fin coupled to the phone at 2 points, the antenna coupled to a transceiver within the phone.

2. A wireless phone having two sets of keys, the sets each having a different number of keys, the sets of keys each separately accessible via the placement of bezel corresponding to the different sets of keys.

3. A method, comprising:
receiving an indication to dial a phone number;
determining if the phone number is an emergency number;
increasing the transmit power, and thus SAR, of a wireless phone if the phone number is an emergency number; and
dialing the phone number.

4. A method, comprising:
receiving a call;
determining the phone number of the caller;
determining if the phone number matches an authorized phone number; and
generating a ring tone if the phone number matches an authorized number.

5. The method of claim 4, further comprising illuminating a button on a wireless phone corresponding to the phone number if the phone number matches an authorized number.

6. The method of claim 4, wherein the authorized phone numbers are stored in a database, and wherein the method further comprises:
receiving a message to add an authorized phone number to the database; and
deleting the added phone number from the database after a period of time.

7. The method of claim 4, wherein if the phone number does not match an authorized phone number then receiving a voice password; determining if the voice password matches a password; and generating a ring tone if the voice password matches the password.

8. A system, comprising:
a dialer engine capable of receiving an indication to dial a phone number, capable of determining if the phone number is an emergency number, and capable of dialing the number; and
a SAR engine capable of increasing the transmit power, thus increasing SAR, of a wireless phone if the phone number is an emergency number.

9. A system, comprising:
a called ID engine capable of determining the phone number of the caller;
an authorizer engine capable of determining if the phone number matches an authorized phone number and generating a ring tone if the phone number matches an authorized number.

10. The system of claim 9, further comprising an LED capable of illuminating a button on a wireless phone corresponding to the phone number if the phone number matches an authorized number.

11. The system of claim 9, wherein the authorized phone numbers are stored in a database, and wherein the system further comprises:
an SMS engine capable of receiving a message to add an authorized phone number to the database and deleting the added phone number from the database after a period of time.

12. The system of claim 9 further comprising a voice recognition engine capable of determining if a voice password matches a password; and wherein the authorizer engine generates a ring tone if the voice password matches the password.

13. A system, comprising:
means for receiving an indication to dial a phone number;
means for determining if the phone number is an emergency number;
means for increasing the SAR of a wireless phone if the phone number is an emergency number; and
dialing the phone number.

14. A system, comprising:
means for receiving a call;
means for determining the phone number of the caller;
means for determining if the phone number matches an authorized phone number; and
means for generating a ring tone if the phone number matches an authorized number.

15. A method, comprising:
entering a phone number on a wireless phone having an antenna disposed in a lanyard-shaped fin, the fin coupled to the phone at 2 points, the antenna coupled to a transceiver within the phone; and
pressing a send key to dial the number.

16. A method, comprising:
providing a wireless phone having two sets of keys, the sets each having a different number of keys, the sets of keys each separately accessible via the placement of bezel corresponding to the different sets of keys; and
changing between the bezels.
